(19) United States
(12) Patent Application Publication
(10) Pub. No.: US 2018/0192321 A1
(43) Pub. Date: Jul. 5, 2018

(54) Reference Signal In A Communications Network

(71) Applicant: Telefonaktiebolaget LM Ericsson (publ), Stockholm (SE)

(72) Inventors: Henrik Sahlin, Göteborg (SE); Niklas Andgart, Lund (SE); David Astely, Stockholm (SE); Jingya Li, Göteborg (SE); Gustav Wikström, Stockholm (SE)

(21) Appl. No.: 15/741,039

(22) PCT Filed: Jul. 14, 2015
(86) PCT No.: PCT/EP2015/066037

§ 371 Date: Dec. 29, 2017

(51) Int. Cl. H04W 28/06; H04L 5/00; H04L 27/26; H04W 72/04; H04B 7/0452

(52) U.S. Cl. CPC H04W 28/06; H04L 5/0051; H04L 5/0037; H04L 5/0044; H04L 5/0007; H04W 72/044; H04W 72/0413; H04B 7/0452; H04L 27/2607

(57) ABSTRACT

A method (110) in a user equipment (105;505) for transmitting a demodulation reference signal in a communications network (100). The method comprises determining (111) multiplexing information for the demodulation reference signal, and transmitting (113) the demodulation reference signal using the multiplexing information in a same time allocation as a demodulation reference signal of another user equipment. The method further comprises transmitting (115) data symbols associated with the demodulation reference signal in a separate time allocation of physical resources, and on a same physical frequency resource, to a time allocation of data symbols of the said another user equipment.

### TECHNICAL FIELD

The present application generally relates to transmitting and receiving reference signals and data in a communications network.

### BACKGROUND

Packet data latency is one of the performance metrics that vendors, operators and also end-users regularly measures. Latency measurements are done in all phases of a radio access network system lifetime, e.g. when verifying a new software release or system component, when deploying a system and when the system is in commercial operation.

Radio resource efficiency could be positively impacted by latency reductions. Lower packet data latency could increase the number of transmissions possible within a certain delay bound. Hence, higher Block Error Rate (BLER) targets could be used for the data transmissions, freeing up radio resources and potentially improving the capacity of the system.

Furthermore, the resource allocation in Long Term Evolution (LTE) is typically described in terms of resource blocks, where a resource block corresponds to one slot (0.5 ms) in the time domain and 12 subcarriers in the frequency domain. Resource blocks are numbered in the frequency domain, starting with 0 from one end of the system bandwidth.

LTE is a radio access technology based on radio access network control and scheduling. These facts impact the latency performance since a transmission of data need a round trip of lower layer control signaling.

The data is created by higher layers, and a User Equipment (UE) modem needs to send a scheduling request (SR) to an evolved NodeB (eNB). The eNB processes this SR and responds with a grant, so the uplink data transfer can start.

FIG. 1 shows an example LTE Release 8 mapping of user data symbols and reference signals within two Physical Uplink Shared Channel (PUSCH) subframes 10, labelled as a first subframe 10a and a second subframe 10b. The subframes 10 are in a time-frequency structure. Each row 11 corresponds to a sub-carrier of different frequency (e.g. separated by 15 kHz), and each column 12 corresponds to a symbol duration at a different time, or basic time unit 12. A resource element 13 consists of one subcarrier during one symbol. Each subframe 10a, 10b comprises 14 symbols in time (for a normal length of cyclic prefix), labelled 0 to 13. The subframes 10a, 10b are each organized in two slots of 7 symbols each, and a plurality of sub-carriers in frequency. A resource block (or physical resource block) is defined as one slot in time, and 180 kHz (e.g. 12 subcarriers) in frequency. A resource block pair, or a physical resource-block pair, may be used to refer to two such resource blocks. References to a subframe may alternatively be referred to as a resource block pair or physical resource block pair. For example, the physical resource block has a limited frequency range (e.g. one set of 12 subcarriers). Data for only one UE is sent on a physical resource block pair.

In LTE release 8, as defined in 3GPP TS 36.211, the reference signals in a PUSCH subframe are transmitted once per slot, and are located in the middle of each slot as shown in FIG. 1. The numbers within the resource element grid refer to an exemplary Transmission Time Interval (TTI) in which a transport block is transmitted. Each box indicates a resource element, used for transmitting a symbol. The number in the lower part of the FIG. 1 denotes an index for uplink symbols, in this example within an LTE release 8 subframe.

Reference signals “R” 16 are inserted into SC-FDMA symbol number 3 and symbol number 10 within a subframe. In the first subframe 10a, data symbols are transmitted in all symbols except for the reference symbols.

The first subframe 10a is transmitted by a first UE, and the data symbols 13 are correspondingly labelled with a ‘1’. The second subframe 10b is transmitted by a second UE of a cell, and the data symbols 13 are correspondingly labelled with a ‘2’. The reference signals R 16 in the first subframe 10a are transmitted by the first UE, and the reference signals R 16 in the second subframe 10b are transmitted by the second UE. The reference signals transmitted in the first subframe 10a may be used for channel estimation of the data symbols 13 of the first subframe 10a, and the reference signals transmitted in the second subframe 10b may be used for channel estimation of the data symbols 13 of the second subframe 10b.

For single carrier formats as used in LTE uplink, each signal is spread over multiple resource elements, and is not located to a single resource element. This is in contrast to Orthogonal frequency-division multiplexing (OFDM) used in LTE downlink.

Wireless access within LTE is based on OFDM in downlink and DFT-spread OFDM (also referred to as Single Carrier Frequency Division Multiple Access FDMA (SC-FDMA) in uplink, for example as described in 3GPP TS 36.211, “Physical Channels and Modulation” Technical Specification, 3rd Generation Partnership Project, Specification Group Radio Access Network, Evolved Universal Terrestrial Radio Access (E-UTRA), V12.5.0. The signal to be transmitted in uplink is pre-coded by a DFT, mapped to a frequency interval in which it is allocated, transformed to the time domain, concatenated with a cyclic prefix and finally transmitted over air. The symbol constructed by the DFT, mapping, IFFT and CP insertion is denoted as a SC-FDMA symbol. Within LTE release 8, a TTI is constructed by 14 such SC-FDMA symbols, for normal cyclic prefix, as illustrated in FIG. 1.

This DFT-spread OFDM as used in uplink has significantly lower Peak to Average Power Ratio (PAPR) as compared to OFDM. By having a low PAPR, the transmitter can be equipped with simpler and less energy consuming radio equipment, which is important for user devices where cost and battery consumptions are important issues.

The reference signals represent an overhead in which user data is not transmitted. An increase in user data transmission is advantageous to increase data transfer rate. A reduction in latency is also advantageous.

### SUMMARY

A first aspect of the present disclosure provides a method in a user equipment for transmitting a demodulation reference signal in a communications network. The method comprises determining multiplexing information for the demodulation reference signal, and transmitting the demodulation reference signal using the multiplexing information in a same time allocation as a demodulation reference signal of another user equipment. The method further comprises transmitting data symbols associated with the demodulation reference signal in a separate time allocation of physical resources, and on a same physical frequency resource, to a time allocation of data symbols of the said another user equipment.

Thus, an overhead represented by the reference signal is reduced. This is particularly advantageous when the TTI of user data is reduced, e.g. to less than a subframe or less than a slot in length of time.

A second aspect of the present disclosure provides a method in a base station for communicating with user equipment in a communications network. The method comprises receiving a first reference signal from a first user equipment, and receiving a second reference signal from a second user equipment. The first and second reference signal are multiplexed. The method further comprises receiving first data symbols from the first user equipment, and receiving second data symbols from the second user equipment. The data symbols from the first and second user equipment are received in a separate time allocation of physical resources and on a same physical frequency resource.

A third aspect of the present disclosure provides a user equipment configured to transmit a demodulation reference signal in a communications network. The user equipment comprises processing circuitry configured to determining multiplexing information for the demodulation reference signal, and radio circuitry configured to transmit the demodulation reference signal using the multiplexing information in a same time allocation as a demodulation reference signal of another user equipment. The radio circuitry configured to transmit data symbols associated with the demodulation reference signal in a separate time allocation of physical resources, and on a same physical frequency resource, to a time allocation of data symbols of the said another user equipment.

A fourth aspect of the present disclosure provides a base station configured to communicate with user equipment in a communications network. The method comprises radio circuitry configured to receive a first reference signal from a first user equipment and a second reference signal from a second user equipment. The first and second reference signal are multiplexed. The radio circuitry is configured to receive first data symbols from the first user equipment and receive second data symbols from the second user equipment. The data symbols from the first and second user equipment are in a separate time allocation of physical resources and on a same physical frequency resource.

A fifth aspect of the present disclosure provides a computer program product, configured when run on a computer to carry out a method as described.

### BRIEF DESCRIPTION OF THE DRAWINGS

Embodiments of the present disclosure will now be described, by way of example only, with reference to the accompanying drawings in which:

FIG. 1 is a prior art allocation of reference signals and data to subframes of a transmission;

FIG. 2 is an example network according to an example of the disclosure;

FIG. 3 is an example allocation of reference signals and data symbols to subframes of a transmission according to an aspect of the disclosure;

FIG. 4 is a further example allocation of reference signals and data symbols to subframes of a transmission according to an aspect of the disclosure;

FIG. 5 is a further example allocation of reference signals and data symbols to subframes of a transmission according to an aspect of the disclosure;

FIG. 6 is a further example allocation of reference signals and data symbols to subframes of a transmission according to an aspect of the disclosure;

FIG. 7 is a further example allocation of reference signals and data symbols to subframes of a transmission according to an aspect of the disclosure;

FIG. 8 is a further example allocation of reference signals and data symbols to subframes of a transmission according to an aspect of the disclosure;

FIG. 9 is a schematic overview of a base station according to an example of the disclosure;

FIG. 10 is a schematic overview of a user equipment according to an example of the disclosure;

FIG. 11 is an example method in a user equipment according to an example of the disclosure; and

FIG. 12 is an example method in a base station according to an example of the disclosure.

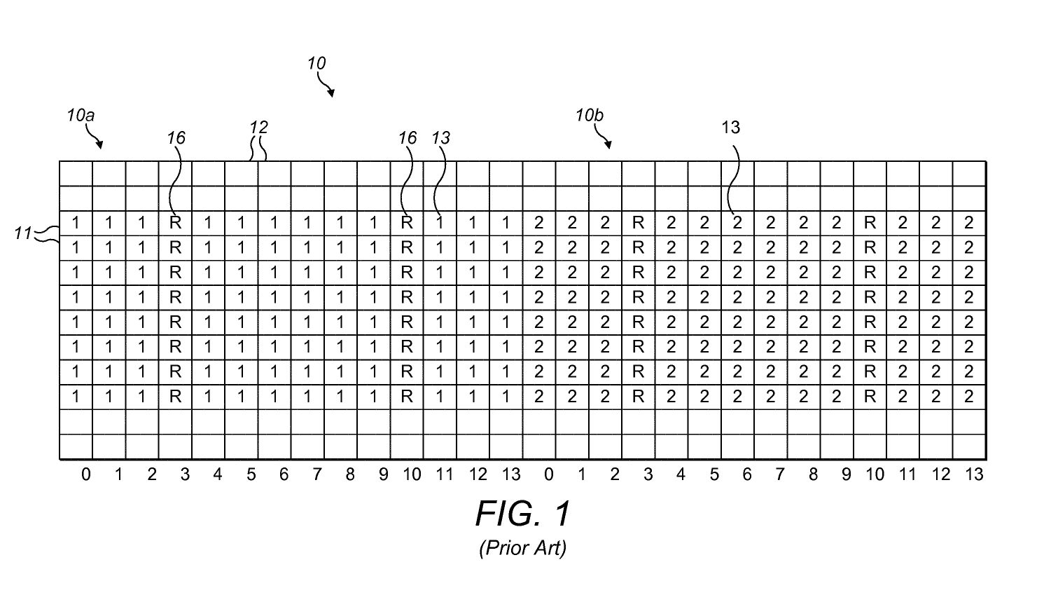

### DETAILED DESCRIPTION

Examples of the disclosure relate to multiplexing reference signals from or to several transmitters into the same symbol, while the user data from or to different transmitters are transmitted in separate symbols. The symbols may be SC-FDMA symbols, for example in uplink from multiple UEs.

The amount of overhead in resource allocation is significantly reduced by multiplexing the reference signals from (or to) multiple UEs into the same symbol. Meanwhile, the user data from one UE is not subject to interference from other UEs, since each UE has a dedicated symbol(s) (e.g. a SC-FDMA symbol) for user data. The single carrier property of the (e.g. uplink) transmissions may be preserved, which has a positive impact on device cost and power consumption.

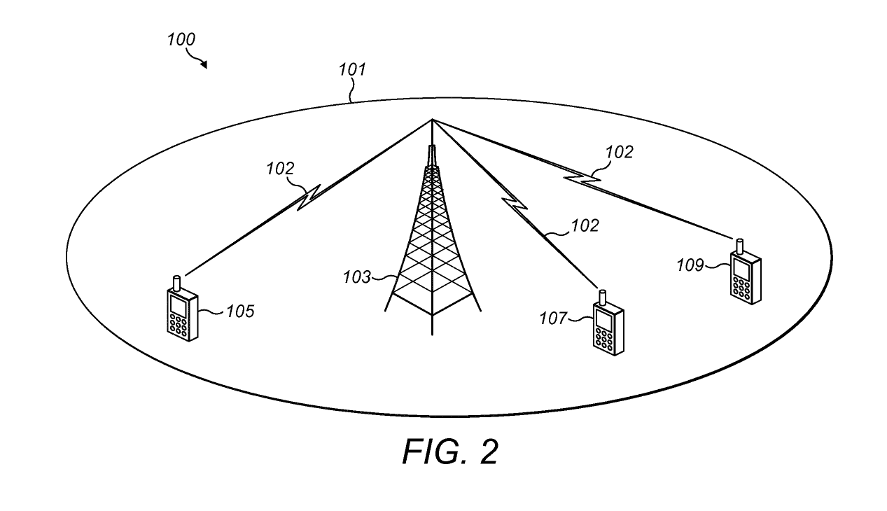

FIG. 2 shows an example communications network 100 in which embodiments relate to transmission or signaling information of reference signals, e.g. demodulation reference signals (DMRS). In some examples, the transmission of the reference signals is a multiplex of transmissions from a plurality of UEs in a cell. The communications network 100 may apply to one or more radio access technologies such as for example LTE, LTE Advanced, WCDMA, GSM, or any 3GPP or other radio access technology.

The communications network 100 comprises network nodes such as e.g. a base station 103 serving a cell 101. The base station 103 may be a base station such as a Radio Base Station, NodeB, e.g. eNB, depending on the technology and terminology used, or any other network unit capable to communicate over a radio carrier 102 with a first user equipment 105 being present in the cell 101. The radio carrier 102 may also be referred to as carrier, radio channel, channel, communication link, radio link or link. The base station 103 may be of different classes, for example a macro base station, such as for example a eNodeB, or a low power base station, such as for example a home eNodeB, pico base station, or femto base station, based on transmission power and thereby also on cell size. Even though FIG. 2 shows the base station 103 serving one cell 101, the base station 103 may serve two or more cells 101. The communications network 100 may further comprise another one or more user equipment, e.g. a second user equipment 107 and a third user equipment 109. In some embodiments, the second user equipment 107 and the third user equipment 109 are present in the same cell 101 as first user equipment 105 and served by the same base station 103.

The communications network 100 may be divided into cells, such as e.g. the cells 101. Thus, the communications network 100 may be referred to as a cellular communications network. A cell is a geographical area where the base station 103 which serves the cell 101, provides radio coverage to user equipments 105 present in the cell 101. A cell 101 may be of different size such as e.g. a micro cell which typically covers a limited area, a pico cell which typically covers a small area, a femto cell which is typically designed for use in a home or small business or a macrocell which typically provides coverage larger than a microcell.

The user equipment 105 present within the cell 101 and served by the base station 103 is in this case capable of communicating with the base station 103 over the radio carrier 102. A data stream(s) is communicated between the base station 103 and the user equipment(s) 105 over the radio channel 102 in a layered approach. Examples of layers are physical layer, data link layer, network layer, transport layer, session layer, etc.

The user equipment 105 may be any suitable communication devices or computational devices with communication capabilities capable to communicate with the base station 103 over the radio channel 102, for instance but not limited to mobile phone, smart phone, personal digital assistant (PDA), laptop, MP3 player or portable DVD player (or similar media content devices), digital camera, or even stationary devices such as a PC. A PC may also be connected via a mobile station as the end station of the broadcasted/multicast media. The user equipment 105 may be embedded communication devices in e.g. electronic photo frames, cardiac surveillance equipment, intrusion or other surveillance equipment, weather data monitoring systems, vehicle, car or transport communication equipment, etc. The user equipment 105 is referred to as UE in some of the figures. The base station 103 may serve a set of plural user equipments 105, 107, 109. The UE may alternatively be referred to as an end device, terminal device, user or terminal.

It should be noted that the radio carrier 102 between the base station 103 and the user equipment 105 may be of any suitable kind comprising either a wired or wireless link. The carrier 102 may use any suitable protocol depending on type and level of layer, e.g. as indicated by the Open Systems Interconnection (OSI) model, as understood by the person skilled in the art.

The following description uses an UpLink (UL) transmission path of an LTE network as an example, although the examples may be applied to the DownLink (DL) and/or to other communication protocols, e.g. as described above. The UL is the link from the user equipment to the base station, and DL is the link from the base station to the user equipment.

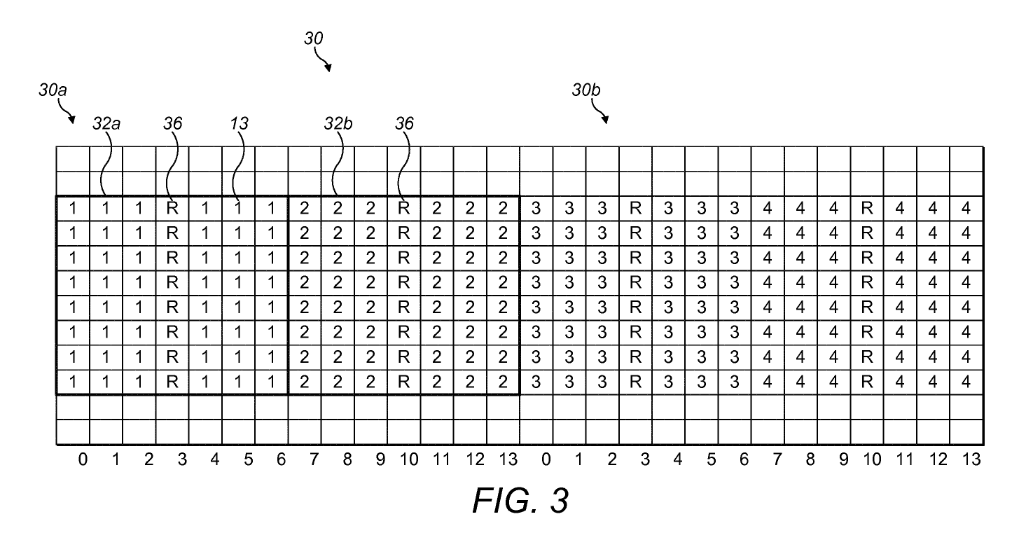

FIG. 3 shows example subframes 30 of a physical transmission resource scheduled for a plurality of UEs. The subframes 30 correspond to a LTE release 8 as described above, except where described otherwise. The symbols 13 correspond to user data or a reference signal, and in some examples, control data. The term subframe may be used to indicate a time period of a physical resource block pair. Alternatively, subframe may be used to indicate a subframe time period and a defined frequency range (e.g. one or more multiples of 12 subcarriers) or one or more physical resource blocks or physical resource block pairs.

The information to be transmitted over the air interface is referred to as the payload. The subframes (e.g. PUSCH subframes) may carry, in addition to payload, any control information necessary to decode the payload such as transport format indicators and MIMO parameters. Such control data is multiplexed with payload prior to DFT spreading. Payload and control data may both be referred to as user data or data, as distinct from reference signals.

In the example illustrated in FIG. 3, scheduling for each UE is based on less than a subframe, e.g. subframe 30a or 30b. In this case, a UE is scheduled with resources that are less than 14 symbols or 1 ms in time. In this example, a first subframe 30a is assigned to two UEs, e.g. first UE 105 and second UE 107. This is in contrast to a conventional scheduling, in which a 1 ms subframe is assigned to only one UE. A first allocation 32a comprises 7 symbols in time, and a second allocation 32b also comprises 7 symbols in time. In this example, the allocations 32a and 32b correspond to the length of one resource block, although examples are not limited to this.

In some examples, the scheduled resources are in uplink. For example, the resources relate to a PUSCH assignment in a subframe, physical resource block or physical resource block pair. The symbols are SC-FDMA symbols. As such, PUSCH assignments do not cover all SC-FDMA symbols in a 1 ms subframe. In some aspects, the frequency resource allocation is as conventionally known, e.g. a resource block has 12 sub-carriers. Aspects of the disclosure are also applicable to transmissions on a Physical Uplink Control Channel (PUCCH).

The allocations 32a, 32b are each Transmission Time Intervals (TTIs) for different UEs. The number ‘1’ in the symbols of the first allocation 32a represents the data symbols for a first UE, and the number ‘2’ in symbols of the second allocation 32b represents data (e.g. user data) symbols for a second UE. In this example, six SC-FDMA symbols with data (e.g. user data) are included in the same TTI.

The subframes 30 comprise one or more reference signals 36, e.g. DM-RS, corresponding to the reference signals described above.

FIG. 3 shows 8 subcarriers (i.e. rows) labelled to indicate data symbols or reference symbols. The number of rows labelled is merely to illustrate principles of the disclosure, and does not limit any example to 8 subcarriers. For example, 12 subcarriers (rows), or a multiple thereof, may be used in any example.

The reference signal transmitted by the UE is in the uplink direction and used by the base station (e.g. eNodeB) to estimate the channel for use in demodulation and decoding of user data, estimate timing and frequency error and/or to estimate the uplink channel quality. The eNodeB can separately use Sounding Reference Signals (SRS), e.g. for uplink frequency selective scheduling or uplink timing estimation as part of a timing alignment procedure.

In this example, a first UE transmitting data symbols in a first allocation 32a also transmits a reference signal 36 in the first allocation 32a (i.e. at symbol 3). In this example, the first UE additionally transmits a further reference symbol outside a time of its allocation of data symbols. In this case, the first UE transmits reference signals in the second allocation 32b, i.e. at symbol 10 of the first subframe 30a. Outside a time of the data symbols may refer to a time in an allocation to another user, or a different resource block, subframe or symbol which is not contiguous in time with the UE's allocated resources for user data. This allows a UE to follow time variations of the radio channel which is outside a time of its allocation of data symbols. In this position, the reference signal 36 is at a central position of the first allocation 32a and in a central position of the second allocation 32b.

A plurality of UEs served by the cell 101 are also configured to transmit a further reference symbol outside a time of their allocation of data symbols. For example, the second UE 107 is scheduled the second allocation 32b of symbols 7, 8, 9, 11, 12, and 13, and transmits a reference signal 36 inserted within its second allocation 32b, i.e. at symbol 10. The second UE 107 is also able to transmit the reference signal at another reference symbol outside its second allocation 32b. In this case, the further reference symbol is transmitted in the first allocation 32a, i.e. the first 7 symbols of the subframe, e.g. symbol 3.

Thus, a first UE transmits data in the first allocation 32a, i.e. six data symbols at symbols 0, 1, 2, 4, 5 and 6. In addition, the first UE transmits a reference symbol at symbol 3, i.e. at the resource element corresponding to symbol 3. In some examples, the first UE also transmits a reference symbol 36 within or adjacent a data symbol allocation of a different UE, e.g. at symbol 10. In this example, the subframe 30a comprises a data allocation for a plurality of UEs, e.g. first and second UEs. Each UE is able to transmit a reference signal at a time interval corresponding to having a data allocation for the whole subframe. As such, the reference signals for each UE are transmitted at a conventional periodicity in a subframe, even though the data allocation (and TTI) is only a part of a subframe for each UE.

In this example, the first and second UE both transmit a reference signal 36 in the same symbol(s), i.e. in the same resource element(s). As such, the first and second UE share an uplink physical resource. The resource shared is a time-frequency resource(s). The first and second UEs transmit independently one or more reference signals. The first and second UEs transmit one or more reference symbols at the same time (and in this example at the same subcarrier in frequency).

The reference symbols 36 of the first and second UEs are multiplexed. The multiplexing allows the eNodeB receiving the reference symbols to differentiate the reference symbol from the first UE and the second UE. For example, each UE is configured to generate and transmit the reference signal to multiplex with reference signals from other UEs (e.g. the second UE). In some examples, the reference signals are multiplexed by code multiplexing. For example, the first UE is configured to generate and transmit the reference signal with a cyclic shift. The cyclic shift provides for multiplexing with other reference signals, for example, by making the reference signal orthogonal to reference signals from other UEs using different cyclic shifts. In some examples, the reference signal is generated using an Orthogonal Cover Code (OCC), to provide for multiplexing.

The cyclic shift (and OCC) provides that each reference signal from a plurality of UEs is orthogonal to each other. In some examples, the reference signal from each of the UEs in the cell is based on the same base sequence (e.g. derived from cell ID). In some examples, the multiplexed reference signals are transmitted in the same cell, i.e. to the same base station.

The second allocation 32b may be considered as separate to the first allocation 32a. As such, the first and second allocations 32a, 32b are separate time allocations of physical resources to data symbols. The allocation 32a of the first UE is separate to that of another allocation 32b of (e.g. the second) UE. In this case, there is no overlap in time between the data symbols transmitted from the separate UEs. The UEs may use the same subcarriers, but different time resources. In some aspects, only the same frequency resources are used by the first and second UEs, i.e. in the first and second allocations 32a, 32b. As such, the first UE is not provided with a different frequency allocation of resources at the same time as the second UE.

The separate time physical resource allocation for data symbols is in contrast to the multiplexed reference signals. The reference signals from a UE and another UE have the same time allocation. For example, the same time allocation is a same symbol. For example, the same symbol is a same symbol or symbol period within a slot, subframe, resource block or resource block pair. The same time allocation may be symbols 3 and 10 of a subframe comprising symbols numbered 0 to 13. In some examples, the reference signals are transmitted on a plurality of subcarriers (frequency range) at the one or more time allocations. Thus, the reference signals are multiplexed in a common time allocation (symbol), whereas the data symbols are separate in time allocation.

In this case, the first and second UE data symbols are transmitted within a subframe time period, and on the same frequency resource. Within that time period, and on the same frequency resources, reference signals for both the first and second UE are transmitted. The reference signals for both the first and second UE are transmitted at a same time (i.e. in a same symbol), e.g. using code multiplexing.

In some examples, each UE allocation 32a, 32b is used for user data and one or more associated reference symbols. In this example, each of the plurality of UEs uses two reference symbols in a 1 ms period, i.e. corresponding to a subframe of LTE release 8. The TTI of a particular UE allocation 32a, 32b is shorter in time than the subframe period (1 ms). One or more further UEs is scheduled an allocation (e.g. the second allocation 32b) in the 1 ms time period. The reference symbols 36 transmitted by UEs which have a data allocation in the 1 ms time period are multiplexed. Thus, the first UE transmits a same number of reference signal symbols in a subframe, although the number of data symbols (or TTI) is reduced to provide a data allocation for a second UE.

In some aspects, the signals are uplink signals and/or utilize SC-FDMA. In this example, latency is improved since PUSCH assignments for a particular UE do not cover all SC-FDMA symbols in a 1 ms subframe. The reduced time length (i.e. reduced number of symbols) in a TTI provides for improved latency.

A plurality of UEs are allocated a separate data allocation of a time-frequency resource which is not shared with another UE of the plurality of UEs. In particular, the separate data allocation is a time allocation of physical resources which is separate to one or more further UEs. In some examples, the one or more further UEs use only the same frequency resources. The separate time allocation does not overlap in time with a time allocation of another UE. The separate time allocation may be considered as a separate scheduling of data for two or more UEs. The time allocation refers to an amount of time in which the UE is scheduled (and so able) to transmit, and not how many data symbols the UE actually transmits in the time allocation. In some aspects, the time allocation may refer to a symbol period, symbol time period or scheduling period.

One or more further UEs may be spatially multiplexed, e.g. using MU-MIMO, as described below. Aspects of the disclosure relate to a set of a plurality of UEs which are not spatially multiplexed with each other, irrespective of any spatial multiplexing with further UEs. Spatially multiplexed UEs may share the same time-frequency physical resources with the plurality of UEs which are multiplexed in a physical resource block or a physical resource block pair. Nevertheless, such spatially multiplexed UEs are not referred to as another UE from which data symbols are transmitted in a separate time allocation of physical resources, or another UE for which reference signals are multiplexed. Such features apply to another UE in the set of UEs which are not spatially multiplexed.

Examples of the disclosure are applicable to data allocations which are scheduled to be received on a same antenna port. Thus, the transmitted symbols of the user equipment and the said another user equipment are scheduled or configured to be received on a same antenna port. Such data allocations are not spatially multiplexed with each other (i.e. separate time and frequency resources are scheduled), although may be spatially multiplexed with data allocations of a yet further UE.

The first and second UE which have multiplexed reference signals and a separate time allocation for data symbols are not frequency multiplexed, i.e. the first and second UE share the same physical frequency resources. The same physical frequency resource may refer to a frequency range of a resource block frequency range (e.g. 12 subcarriers), a frequency range of a plurality of resource blocks or other radio frequency range. The data symbols of the UE are transmitted on a same physical frequency resource as data symbols of another UE. In some aspects, a frequency range allocated to data symbols a first UE is the same as (or overlapping) with a frequency range allocated to data symbols of a second UE. The multiplexed demodulation reference signals are transmitted by the first and second UEs in the same frequency range.

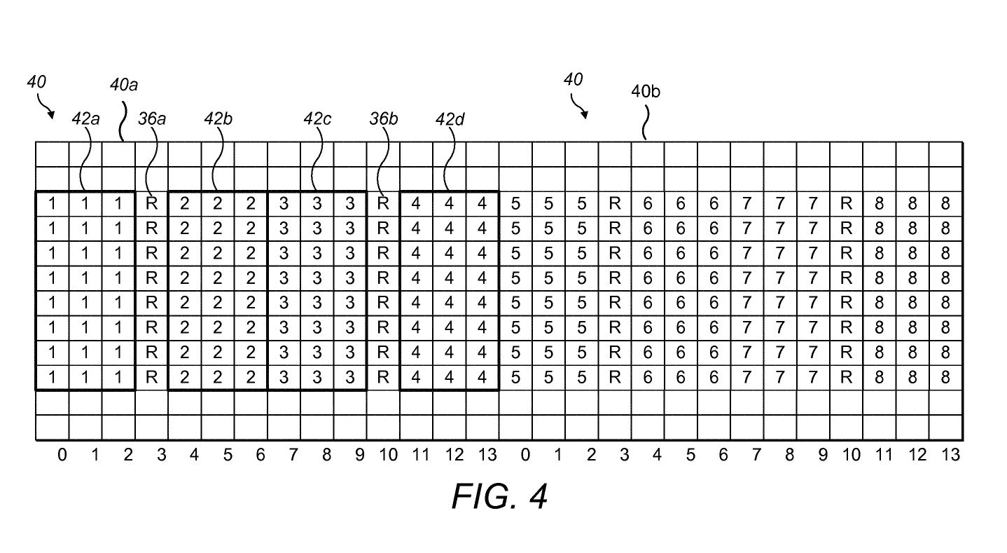

In FIG. 4, subframes 40 are constructed by transmissions from a plurality of UEs which are arranged as shown. In this example, a first data allocation 42a of a first UE has three symbols (e.g. SC-FDMA symbols). The data in the first allocation 42a defines a TTI. This reduced TTI (data allocation) provides for a reduced latency, and allows more UEs to be time multiplexed into a subframe.

In this example, four UEs transmit data in a subframe, and on a same frequency resource. For example, in subframe 40a the four UEs are scheduled in a first data allocation 42a, a second data allocation 42b, a third data allocation 42c and a fourth data allocation 42d, labelled as ‘1’, ‘2’, ‘3’ and ‘4’ respectively. The data symbols of the first allocation 42a are transmitted by a first UE, and the data symbols of the second allocation 42b are transmitted by a second UE. The data symbols of the third allocation 42c are transmitted by a third UE, and the data symbols of the fourth allocation 42d are transmitted by a fourth UE. A plurality of UEs (first and second UEs) may be considered as having separate data allocations in a resource block, or a plurality of UEs (first to fourth UEs) may be considered as having separate data allocations in a resource block pair. The first to fourth UEs may be considered as scheduled in different time allocations of a same frequency resource. A subsequent subframe 40b may be used for scheduling further UEs, e.g. fifth to eighth UEs, labelled as ‘5’, ‘6’, ‘7’ and ‘8’.

The 1 ms subframe time length has two time units (symbols) for reference signals, e.g. a first reference symbol 36a at the position of symbol 3 and a second reference symbol 36b at the position of symbol 10. In some examples, the first reference symbol 36a comprises multiplexed reference symbols from all UEs having a data allocation in that subframe or physical resource block pair. The second reference symbol 36b also comprises multiplexed reference symbols from all UEs having a data allocation in that subframe or physical resource block pair. In this case, all reference symbols in the subframe or physical resource block pair comprise multiplexed reference signals from all of the plurality of UEs transmitting data in that physical resource block pair, e.g. first to fourth UEs. A reference signal may be transmitted by a UE at a time which is not contiguous with a data symbol, e.g. a reference signal at symbol 10 for the first UE having a data allocation 42a. At a particular time, data for only one UE is transmitted in the physical resource block.

This allows the receiver a high accuracy in following time variations in the channel. This is the case even when a particular UE is not transmitting data on the whole time length, e.g. over the whole time length of the subframe.

In a further example, a particular reference symbol comprises multiplexed reference signals from only a subset of UEs transmitting data within the subframe. For examples, the first reference symbol 36a comprises multiplexed reference signals from only the first and second UEs transmitting data in the first and second allocations 42a, 42b respectively. The second reference symbol 36b comprises multiplexed reference signals from only the third and fourth UEs transmitting data in the third and fourth allocations 42c, 42d respectively. In this case, a subframe or resource block pair comprises data from a plurality of UEs, and each UE transmits a reference signal at only one symbol position. Thus, each UE transmits a reference signal at only symbol time in a subframe, i.e. does not transmit at a further reference signal symbol time in the subframe. This provides for the receiver to not have to wait for both reference signals in a subframe time length before processing (demodulation) of the user data symbols. For example, a reference signal is inserted directly before or after a data allocation 42a, 42b, 42c, 42d to a UE.

In some examples, a reference symbol 36a, 36b between two blocks of user data symbols includes reference signals for at least those two users allocated to user data before and after the reference symbol.

In these examples, a plurality of UEs are scheduled a separate time allocation of data symbols in a slot or physical resource block. A reference signal is transmitted by the separately scheduled UEs in that slot or physical resource block. Such reference signals are multiplexed. The multiplexed reference signals may be the reference signals for some or all of the UEs scheduled for that slot or physical resource block, or subframe or physical resource block pair.

The term subframe may be used to indicate a physical resource block pair. Alternatively, subframe may be used to indicate a subframe time interval and a defined frequency range (e.g. one or more multiples of 12 subcarriers or one or more physical resource blocks). The frequency range may be a frequency range allocated to a set of UEs which are time multiplexed, as described above. In the frequency range, only one UE is allocated or transmits a data symbol at a particular time.

The allocation of physical resources according to the disclosure is based on physical time and frequency resources. Aspects relate to a plurality of UEs sharing in a physical resource block or physical resource block pair. The plurality of UEs may transmit on a frequency range which is larger than one physical resource block or physical resource block pair (e.g. 12 subcarriers).

The frequency range, or subframe, referred to does not provide for frequency multiplexing of other UEs. Thus, a separate time allocation of physical resources to data symbols refers to a separate time allocation for those UEs sharing the same a physical resource block, physical resource block pair or subframe over the limited frequency range.

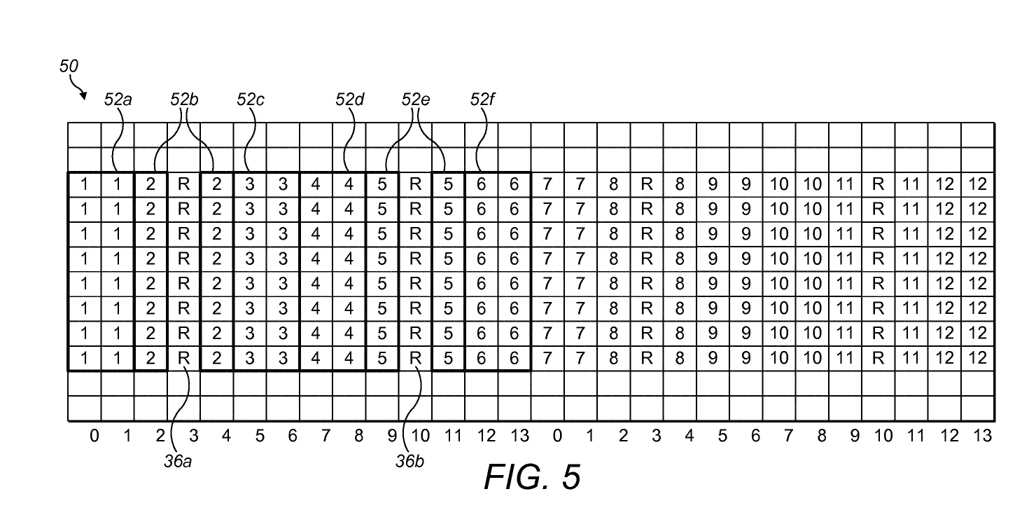

FIG. 5 shows a further example of the allocation of physical resources in subframes 50. In this example, two symbols (e.g. SC-FDMA) in a data allocation are included in the same TTI. Thus, a block of two data symbols may be allocated or scheduled as a TTI for a UE. For example, a subframe 50 comprises a first allocation 52a, a second allocation 52b, a third allocation 52c, a fourth allocation 52d, a fifth allocation 52e and a sixth allocation 52f. Each allocation 52a, 52b, 52c, 52d, 52e, 52f is for a separate first to sixth UE in a cell.

As such, each data symbol has a particular or unique time allocation of physical resources. In some aspects, different time resources are allocated to each UE transmitting within a subframe. A frequency resource, e.g. corresponding to one or more physical resource block pairs, is used by such UEs. This allocation of physical resources is particular for a serving cell of a base station (for example implemented as an eNodeB) of the communications network.

As described in the examples above, each 1 ms subframe comprises a first reference symbol 36a and a second reference symbol 36b. In this example, the symbol with the multiplexed reference signals is not necessarily placed next to the data symbols associated with the same UE. The reference symbols are used to multiplex reference signals from multiple users. The reference symbols 36a, 36b, used for demodulation of the user data, may be located before or after the corresponding data (e.g. user data). For example, a first allocation 52a of two data symbols is not adjacent in time to any reference signal, e.g. first reference symbol 36a. In this case, the first allocation 52a is scheduled before the first reference symbol 36a. In a further example, the third allocation 52c is not adjacent in time to the first or second reference symbols 36a, 36b and is scheduled after the first reference symbol 36a. Thus, a UE may transmit a reference signal to be multiplexed after and/or before a (non-multiplexed) data symbols. As described above, first and second reference symbols 36a, 36b may each contain reference signals for all UEs scheduled in that subframe, or only some (a subset) of the UEs scheduled in that subframe.

In some aspects, a plurality of reference symbols can be combined, or interpolated, in order to improve the channel estimates at the positions for user data symbols.

In this example, data symbols for one or more allocations to a UE (i.e. in a TTI) are not adjacent in time to each other. For example, the second allocation 52b is split by the first reference symbol 36a, such that the second allocation 52b is both before and after in time of the first reference symbol 36a. The second allocation 52b (or TTI) of data symbols is at symbols 2 and 4. The reference symbols 36a, 36b are in conventional positions in the 1 ms subframe. In some aspects, such split data allocations 52b, 52e have a higher latency of the transmitted data, than contiguous data allocations e.g. the third allocation 52c. The third allocation 52c is after the reference signals 36a, and so the eNodeB does not need to wait to decode the data. The eNodeB waits until reference signals 36a in symbol 3 are received before being able to decode the data in the first allocation 52a.

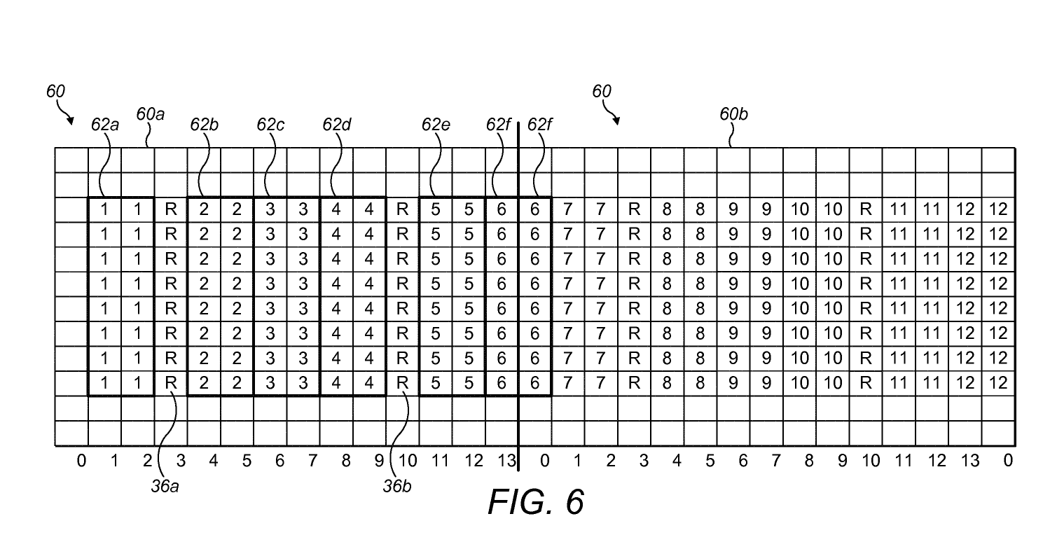

FIG. 6 shows subframes 60 having an alternative mapping of data symbols. In this example, data (e.g. SC-FDMA) symbols are shifted one symbol in time, as compared to the example in FIG. 5. As for the example of FIG. 5, two data symbols are transmitted in a TTI or data allocation to a UE per subframe. In the example of FIG. 6, the two data symbols from one UE are located adjacent to each other in time. As such, the TTI for a UE is not split around a reference signal.

A first to fifth allocations 62a, 62b, 62c, 62d, 62e are transmitted in a first subframe 60a. The first allocation 62a starts after the start of the subframe, e.g. at symbol 1. The reference symbols are located in the conventional positions within the subframe, i.e. at symbols 3 and 10. The subframes 60 are arranged such that none of the data allocations are split into two non-contiguous parts by the reference signals. For example, the second allocation 62b is not split by the first reference symbol 36a, as described in FIG. 5. Instead, the second allocation 62b follows the first reference symbol 36a.

In this example, the data symbols of one UE may be split between a first subframe 60a and a subsequent, second, subframe 60b or physical resource block pair. In this example, data symbols of a sixth allocation 62f is split between subframes 60a, 60b. The subframes 60a, 60b may be referred to as a pair of subframes or adjacent resource block pairs. Thus, the separate physical resource allocation of the data symbols is a separate time allocation in a pair of subframes of the communication to another user equipment. The pair of subframes refers to the time period of a pair of subframes, e.g. 2 ms. The examples are described with respect to LTE release 8 sub-frames of 1 ms. The reference signals are multiplexed, as described in any example above.

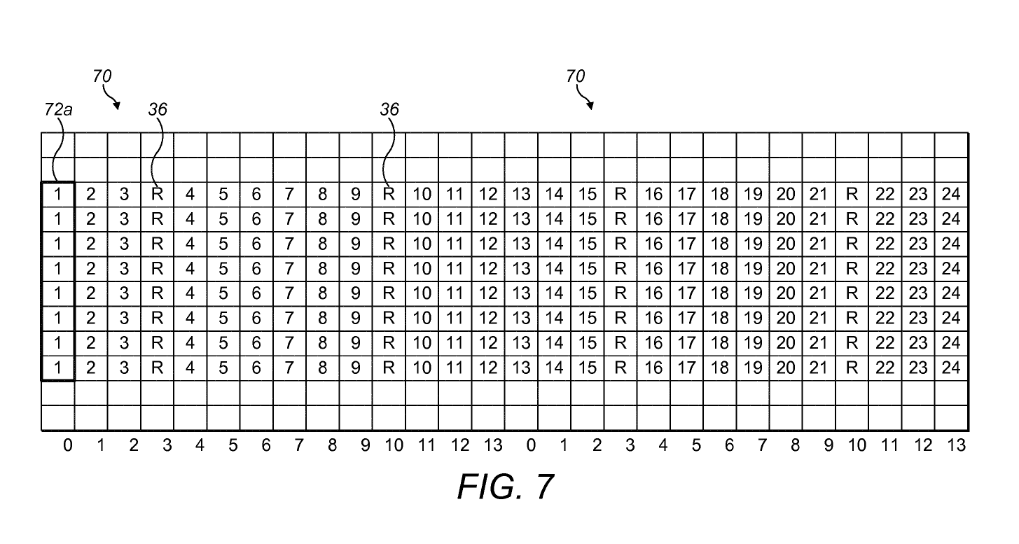

FIG. 7 shows a further example of a mapping of data symbols into subframes 70. In this example, only one data symbol is included in the same TTI. Each UE is allocated only a single data symbol per subframe or physical resource block pair. For example, a first data allocation 72a for a first UE has only one symbol in the subframe. In this example, 12 UEs have separate time allocations for data in a subframe time period and the same physical frequency resource. The first UE additionally transmits one or more reference signal symbols 36 in the subframe. The reference signals of a plurality of UEs are multiplexed into the same reference symbol. The reference signals are multiplexed as described in any example above, e.g. all UEs transmitting in the subframe transmit in all reference signal symbols or only in one reference signal symbol. As such, each reference signal symbol is a multiplex of all or a subset of the reference signals from the UEs transmitting data in that subframe or physical resource block pair.

In any of the examples described, reference signals are code multiplexed into the same symbol(s). For example, the reference signals are multiplexed using cyclic shifts (and OCC). Up to 12 different UEs can be code-multiplexed into the same symbol by using cyclic shifts e.g. as defined within the specification of LTE release 8, for example in 3GPP TS 36.211, “Physical Channels and Modulation” Technical Specification, 3rd Generation Partnership Project, Specification Group Radio Access Network, Evolved Universal Terrestrial Radio Access (E-UTRA), V12.5.0. http://www.3gpp.org/ftp/Specs/archive/36_series/. A cyclic shift may be considered as a frequency domain linear phase rotation of the reference signal.

The UEs may be configured to use different time cyclic shifts of the reference signals within the same SC-FDMA symbol. This cyclic shift corresponds to a known cyclic time delay of the reference signal. If this cyclic time delay is larger than the delay spread of the radio channel, then the receiver can estimate the channels for different users separately.

Alternatively or in addition, the reference signals 36 from a plurality of UEs transmitting in a same slot, subframe, physical resource block or physical resource block pair may be frequency multiplexed. For example, the reference signals 36 of any example may be multiplexed using frequency combs. Reference signals may be considered as repeating at predetermined frequency or subcarrier interval. For example, a “repetition factor” of six may be used, so that the reference signals from a UE are transmitted on every 6th carrier. In some examples, a LTE release 8 Cell specific Reference Signals (CRS) design is used, e.g. if relevant for the radio channel coherency bandwidths. In some examples, the frequency multiplexing is over the same frequency resource as used by the data allocations. A plurality of the frequency multiplexed demodulation reference signals are transmitted at a same time, e.g. symbol 3 and/or symbol 10 in a subframe.

In some aspects, if a plurality of reference signals are multiplexed by different frequency combs, the number of reference signals multiplexed by cyclic shifts is decreased with the same amount. In some examples, frequency combs and cyclic shifts can be combined, and configured such that interference is low between different reference signals corresponding to different cyclic shifts and combs.

In some aspects, the plurality of demodulation reference signals are multiplexed by code multiplexing or by frequency multiplexing. The reference signals of a set of a plurality of UEs are not multiplexed by spatial multiplexing. The reference signals of this set of UEs are multiplexed by code or frequency multiplexing. For this set of UEs, each UE has a separate time allocation of data symbols. The separate time allocation of data symbols is for a frequency range (e.g. resource block) used only by that set of UEs. The frequency multiplexing of the reference signals is within the frequency range or resource block or resource block pair used by the set of UEs. In some aspects, a UE of the set of UEs may (or may not) be spatially multiplexed an/or frequency multiplexed with one or more further UEs. Aspects of the disclosure apply to a set of UEs in a limited frequency range (e.g. a resource block frequency range) and to a set of UEs which are not spatially multiplexed with other UEs in that set.

In some aspects, a reference signal is multiplexed using both a code multiplexing (e.g. cyclic shift/OCC) and frequency multiplexed (e.g. using a frequency comb). The UEs are configured with one or more parameters such that interference is low between different reference signals corresponding to different codes (e.g. cyclic shifts) and frequencies (e.g. combs).

The multiplexed reference signals from different UEs may be considered as transmitted at a same basic time unit of a subframe. In this case, resource elements sharing an allocated time basic unit are used for a plurality of reference symbols. The multiplexed reference symbols are from UEs which are also transmitting data within the resource block or resource block pair. In some examples, the resource block or resource block pair corresponds to a time-frequency physical resource, e.g. 7 or 14 symbols in a time domain and 12 subcarriers in a frequency domain.

In some aspects, the reference signal is transmitted in a physical resource together with the data symbols. As such, the reference signal is transmitted in a same resource block or subframe, or a time adjacent resource block or subframe, as the data symbols transmitted from the UE. For example, the frequency bandwidth (i.e. subcarriers used) by the reference signals is the same as the data from the UE. In some aspects, the reference signal is always transmitted in the physical resource together or associated with the data symbols.

In the above examples, the reference symbol is placed in the center symbol (e.g. SC-FDMA symbol) of a slot or resource block. As such, the reference symbol is at a time center of the slot. Alternatively, the reference symbol may be inserted in a different position, without changing the principle of this disclosure. The use of the reference signal in the middle of the slot allows a base station (e.g. eNodeB) to use the reference symbol for interference measurements for a mix of legacy release 8 UEs and UEs operating according to a method of the present disclosure. The position of the reference signal as the center symbol, as also used by legacy UEs, means the reference symbol represents a worst case interference scenario.

When the length of the TTI is reduced (i.e. to less than a slot or subframe length), one or more reference signals transmitted for each TTI represents a relatively increased overhead, and a corresponding decrease in data rate. For example, in a two symbol TTI, only half the symbols could be used for data transmission (one data symbol and one reference symbol), compared to 12 out of 14 symbols (12 data symbols, 2 reference symbols) that are used in LTE release 8. In addition, in the case of a one symbol TTI, the current uplink (SC-FDMA) structure cannot be used since a symbol can be used for either a reference signal or data, but not both. The multiplexing of reference symbols, for non-multiplexed data symbols, provides for a reduced overhead or increased data rate. The multiplexing of the reference signals from different UEs may also be considered to allow the same number of reference symbols to be used by each UE, even though its data allocation has a reduced TTI or transmission length within a subframe. In some examples, the TTI is considered as the time interval from a first transmitted data symbol to a last transmitted data symbol for which the data symbols are jointly channel coded. This may exclude the reference symbols, e.g. reference signal symbols which are not contiguous in time with the associated data symbols. The reference signals (DM-RS) are still transmitted by the UE and associated with data; examples of the disclosure provide for a reduced latency without a change to reference signal transmission timings.

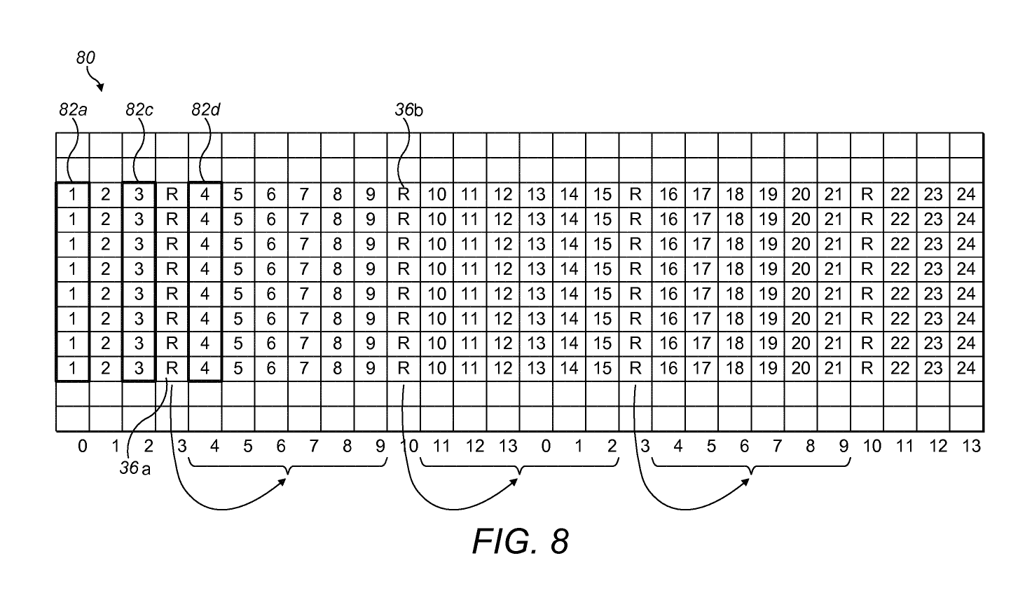

FIG. 8 shows a further example of subframes 80 of the disclosure. As described above in FIG. 7, a resource allocation is provided for a UE to transmit reference signals 36 and data symbols in a subframe 80, in which the reference signals (but not the data symbols) are multiplexed. The data allocation for each UE in a subframe is one symbol period, e.g. a first data allocation 82a has a length (TTI) of one symbol. In this example, the reference symbol 36 allocated for a UE is prior (i.e. transmitted before) the data from a particular UE.

For example, for a third data allocation 82c for a third UE, the closest reference signal is the first reference symbol 36a which directly follows the third data allocation 82c. In this example, the reference symbol 36a is not used by the third UE. Instead, the third UE uses a preceding reference symbol (not shown) from an earlier frame. For a fourth data allocation 82d, the preceding reference symbol 36a is used for transmission of the reference signal. This is also the closest reference symbol in time. Reference signals from UEs having data allocations on symbols 4 to 9 (fourth to ninth UEs) are multiplexed into a single reference signal 36a. Reference signals from UEs having data allocations on symbol 11 to symbol 2 of a subsequent subframe (tenth to fifteenth UEs) are multiplexed into a further single reference signal 36b. The data allocations and associated reference signals may be considered as arranged over a pair of subframes, two resource blocs or a two physical resource block pairs.

For a method in which the reference symbol is transmitted before the data symbol(s), the channel estimate will always be available. Thus, there is no additional waiting time before a channel estimate is obtained.

This in contrast to an alternative, which may be used in any of the examples above, of a UE using the closest (in time) reference symbols to the data symbols, irrespective of whether the reference symbol is before or after the data symbol(s). In some examples, a UE can transmit reference signals in all reference signal symbol allocations such that a channel estimate is available close to the user data. Also, the UE is then prepared to receive and process a possible reception of user data.

The reference signals can be transmitted in several symbols (e.g. SC-FDM symbols) in a slot or a sub-frame period. When increasing the number of symbols used for reference signals, more users can be multiplexed, at a cost of higher reference signals overhead.

The use of the closest reference symbol allocation to data provides for a high quality of the channel estimate, particularly in a fading channel. For a low-speed UE, fading may not be a limitation, and transmitting a reference symbol prior to the data may be utilized effectively. In some examples, a bandwidth of reference signals and a bandwidth of the data transmission on the physical uplink channel (e.g. PUSCH) are not the same. The UE may be configured to transmit the reference signal before it has been (dynamically) configured to transmit the data, e.g. on PUSCH. In such a case, the reference signal may cover a different (e.g. larger) bandwidth as compared to the actual data (e.g. PUSCH) transmission.

In MU-MIMO, several UEs share the same time and frequency resources. Examples of the application are applicable to MU-MIMO, for example, uplink MU-MIMO. In this case, the plurality of user equipment are spatially multiplexed (Space Division Multiple Access).

For any of the examples described a plurality of UEs may transmit within a same symbol of the time-frequency resource. This requires several receiver antennas (e.g. at the base station), a receiver which is capable of multi-user detection in the demodulation and a radio channel which is rich enough for separation of the user signals in the demodulation. Within this demodulation, the radio channel for each user must be estimated. The reference signals are multiplexed in a symbol (e.g. a SC-FDM symbol) at a particular time in a subframe when using spatial multiplexing of users with MU-MIMO, in a similar manner as described previously for time multiplexing of users. Here, the spatial multiplexed users might use different cyclic shift or frequency combs for the different reference signals.

In an UL MU-MIMO embodiment, user data are transmitted from a subset of the transmitters transmitting reference signals in the same SC-FDMA symbol.

In some examples, the communication of the user equipment in the communications network is based on Frequency Division Duplex (FDD). Examples of the disclosure may also be used in a Time Division Duplex communications network.

In some examples, the reference signals are used by the base station for channel estimation for coherent demodulation of the uplink physical channels. A demodulation reference signal may only be transmitted with the channel it is used for, e.g. PUSCH or PUCCH. The reference signals span at least the same frequency range as the corresponding physical channel. In some aspects, a demodulation reference signal may be considered as associated with a data symbol if the demodulation reference signal is used to demodulate the data symbol. Thus, examples of the disclosure relate to associated demodulation reference signals and data symbols. The associated reference signal and data are transmitted from the same UE. The associated demodulation reference signal and data symbols may be transmitted in adjacent symbol periods, or the demodulation reference signal and data symbols may be in non-adjacent symbol periods. The associated demodulation reference signal and data symbols may be in a same slot of subframe time period. In some examples, the associated demodulation reference signal and data symbols are transmitted over a period of two subframes.

The examples are applicable to UEs in communication with the same base station. In this case, the UEs multiplexing reference signals are transmitting the reference signals and data symbols to the same base station (e.g. eNB). In some examples, the base station used for uplink and downlink are different. In this example, the a base station used for signaling the user equipment (in downlink) is different to a base station receiving the signals in uplink. This example may be implemented if a first base station has better downlink than a second base station, while the uplink is better for the second base station (as compared to the first base station).

Examples of the disclosure provide for packet latency reductions by the reduction of transport time of data and control signaling (e.g. by reducing the length of a TTI) and/or the reduction of processing time of control signaling (e.g. the time it takes for a UE to process a grant signal).

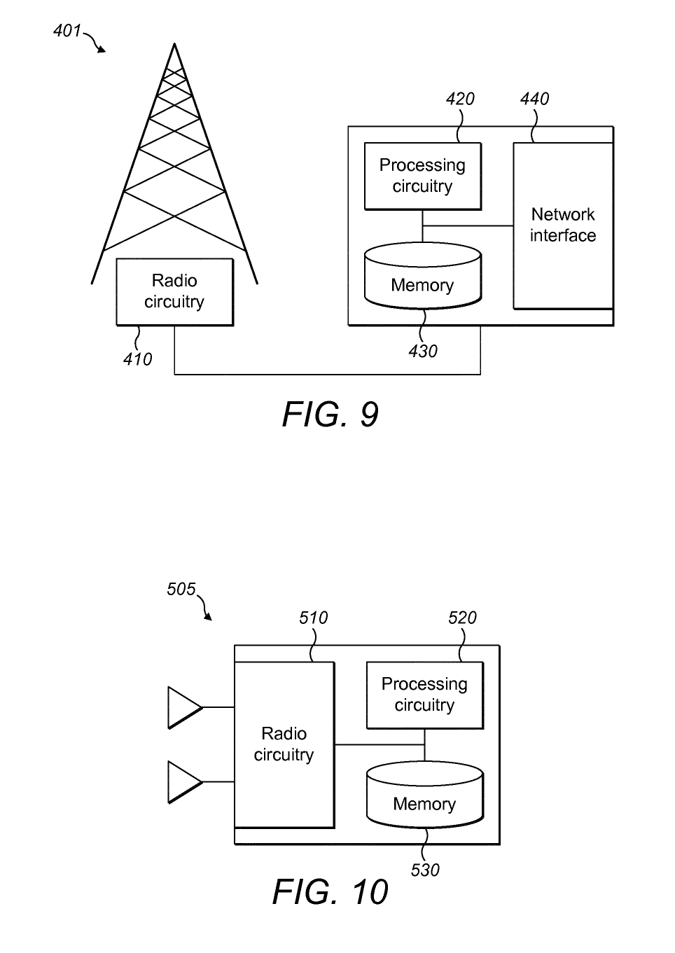

FIG. 9 illustrates an example node configuration of a base station or eNB 401 which may perform some of the example embodiments described herein. The base station 401 may comprise radio circuitry or a communication port 410 that may be configured to receive and/or transmit communication data, instructions, and/or messages. It should be appreciated that the radio circuitry or communication port 410 may be comprised as any number of transceiving, receiving, and/or transmitting units or circuitry. It should further be appreciated that the radio circuitry or communication port 410 may be in the form of any input or output communications port known in the art. The radio circuitry or communication port 410 may comprise RF circuitry and baseband processing circuitry (not shown).

The base station 401 may also comprise a processing unit or circuitry 420 which may be configured to provide scheduling for configuring a UE according to any example of the disclosure. The processing circuitry 420 may be any suitable type of computation unit, for example, a microprocessor, digital signal processor (DSP), field programmable gate array (FPGA), or application specific integrated circuit (ASIC), or any other form of circuitry. The base station 401 may further comprise a memory unit or circuitry 430 which may be any suitable type of computer readable memory and may be of volatile and/or non-volatile type. The memory 430 may be configured to store received, transmitted, and/or measured data, device parameters, communication priorities, and/or executable program instructions. In some examples, the base station 401 further comprises a network interface 440 for communication with one or more further base stations and/or a core network.

FIG. 10 illustrates an example node configuration of a UE or wireless terminal 505 which may perform one or more of the examples described. The wireless terminal 505 may be a user equipment, machine-to-machine type device, or any other device capable of communicating with a communications network. The wireless terminal 505 may comprise radio circuitry or a communication port 510 that may be configured to receive and/or transmit communication data, instructions, and/or messages. It should be appreciated that the radio circuitry or communication port 510 may be comprised as any number of transceiving, receiving, and/or transmitting units or circuitry. It should further be appreciated that the radio circuitry or communication port 510 may be in the form of any input or output communications port known in the art. The radio circuitry or communication port 510 may comprise RF circuitry and baseband processing circuitry (not shown).

The wireless terminal 505 may also comprise a processing unit or circuitry 520 which may be configured to obtain downlink broadcast transmission, for example to receive signaling to configure any example of the disclosure. The processing circuitry or unit may be configured to transmit data symbols and multiplexed reference signals in accordance with any example. The processing circuity is configured to transmit, via the communication circuitry, a subframe comprising the multiplexed reference signal and user data in separate symbols. The device may be otherwise configured as described above.

The processing circuitry 520 may be any suitable type of computation unit, for example, a microprocessor, digital signal processor (DSP), field programmable gate array (FPGA), or application specific integrated circuit (ASIC), or any other form of circuitry. The wireless terminal 505 may further comprise a memory unit or circuitry 530 which may be any suitable type of computer readable memory and may be of volatile and/or non-volatile type. The memory 530 may be configured to store received, transmitted, and/or measured data, device parameters, communication priorities, and/or executable program instructions.

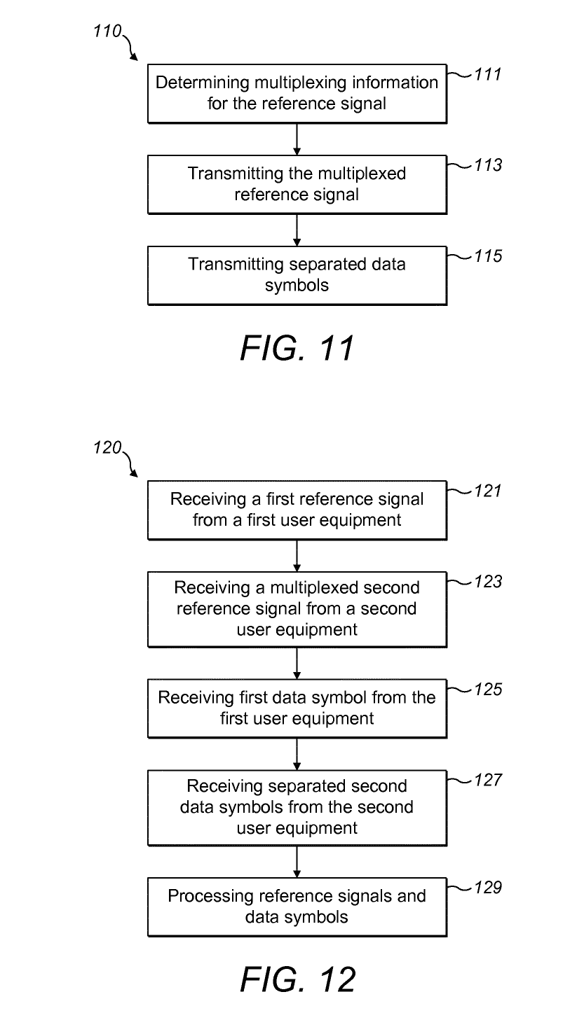

FIG. 11 is a flow diagram 110 depicting example operations which may be taken by the wireless terminal 105;505 as described herein for transmitting reference signals. It should be appreciated that these operations need not be performed in order, and any may be performed simultaneously. Furthermore, it should be appreciated that not all of the operations need to be performed. The example operations may be performed in any order and in any combination.

In 111, the UE determines multiplexing information for the reference signal. The multiplexing information may be received in signaling from the network, or may be determined by the UE based on internally stored information or one or more measured parameter. The multiplexing information may be information of a code multiplexing to use (e.g. a cyclic shift and/or OCC) and/or a frequency multiplexing configuration. Such resources are scheduled by an eNodeB or other network entity. In some examples, the signaling is similar to known signaling used for cyclic shifts in MU-MIMO. In some aspects, the UE is configured to receive a scheduling for transmission of data from the base station. The received scheduling is for a separate time allocation of data symbol transmission to the data symbol transmission of other UEs using the same frequency resource, and with which UE transmits a multiplexed reference signal.

In 113, the UE transmits the reference signal. The reference signal is transmitted on a determined time-frequency resource. The transmitted reference signal is multiplexed with reference signals from other UEs. This allows a receiving base station to isolate and independently process the reference signals from each UE.

In 115, the UE transmits the data symbols. The transmission of the data symbols is before and/or after a reference signal used for demodulation of the data symbols. The data symbols are transmitted in a scheduled time resource which is separate to the time resource scheduled for other UEs using the same frequency and same receive antenna port.

FIG. 12 is a flow diagram 120 depicting example operations which may be taken by the base station 103, 401 as described herein for scheduling uplink transmission of reference signals and data symbols. It should be appreciated that these operations need not be performed in order, and any may be performed simultaneously. Furthermore, it should be appreciated that not all of the operations need to be performed. The example operations may be performed in any order and in any combination.

In 121, the base station receives a first reference signal from a first UE. At the same time, in 123, the base station receives a multiplexed second reference signal from a second UE. The base station demultiplexes the first and second reference signal, e.g. by code and/or frequency demultiplexing.

In 125, the base station receives the first data symbols. The first data symbols are received in a time allocation of a subframe associated with the first UE.

In 127, the base station receives the second data symbols. The second data symbols are received in a separate time allocation of a subframe associated with the second UE. The second data symbols are received only after receiving of the first data symbols has finished.

In 129, the base station processes the received reference signals and data symbols. For example, the base station demodulates the first and second data symbols based on the associated received reference signal. The demodulation may use a channel estimation derived from the reference signal.

In a further aspect, the base station transmits multiplexing information to the first and second UE, in order to provide for multiplexed reference signals of the first and second UE. The information transmitted provides for multiplexed reference signals to be separated by the base station.

In a further aspect, the base station determines a scheduling for a plurality of UEs served by the base station. The base station determines the scheduling according to any example, e.g. determines a common time allocation for a plurality of UEs to transmit demodulation reference signals and a separate time allocation in each subframe (or plurality of subframes) for each UE to separately transmit associated data. The base station is configured to transmit corresponding scheduling information to the first and second UE, in order to schedule the first and second UE data and/or reference signal allocation.

The present disclosure may, of course, be carried out in other ways than those specifically set forth herein without departing from essential characteristics of the disclosure. The present embodiments are to be considered in all respects as illustrative and not restrictive.

Those skilled in the art will appreciate that embodiments herein generally include a method implemented by a communication device in a wireless communication network. The method is for transmitting a reference signal (e.g. DM-RS) with data (e.g., user data) over a PUSCH in an LTE network). The method may comprise generating and transmitting a reference signal which is suitable to be multiplexed, e.g. orthogonal to reference signals from other UEs transmitting on the same symbol (i.e. on the same time and frequency physical resource).

One or more embodiments herein also include corresponding communication devices, computer programs, and computer program products.

A communication device may comprise for example communication circuitry configured to send and receive wireless communication, and processing circuitry communicatively coupled to the communication circuitry. The processing circuity may be configured to determine an allocation of data symbols, a reference signal configuration and/or transmit the data symbols and reference signal. The device may be configured as described above. A computer program comprises instructions which, when executed by at least one processor of a device, causes the device to carry out any of the methods herein.

A carrier contains the computer program above, wherein the carrier is one of an electronic signal, optical signal, radio signal, or computer readable storage medium.

A number of implementations may benefit from a reduced latency provided by examples of the disclosure. For example, aspects may provide an increased perceived quality of experience: examples are gaming, real-time applications e.g. VoLTE/OTT VoIP and multi-party video conferencing. Further applications which are delay critical may also utilize aspects of the disclosure, for example, remote control/driving of vehicles, augmented reality applications in e.g. smart glasses, or specific machine communications requiring low latency.

It should also be noted that reduced latency of data transport may also indirectly give faster radio control plane procedures like call set-up/bearer set-up, due to the faster transport of higher layers control signaling.

Any reference to a subframe may refer to a time period of a subframe, e.g. 1 ms. References to a subframe may refer to only a subset of the frequency resources of the subframe, e.g. the frequency resources of a resource block or resource block pair. Such frequency resources are shared by a set of UEs served by a cell, in some examples, a subset of the UEs served by the cell. Further UEs operating using different frequency resources are not part of the set of UEs, which are defined as operating according to the disclosure herein.

Aspects of the disclosure are applicable to downlink and/or device-to-device transmissions, as well as for uplink. For example, any reference to uplink from a UE to a base station may be inverted to refer to downlink from one or more base station to a UE. For example, aspects may utilize the described single carrier, providing low PAPR, not for uplink but for downlink and/or device-to-device transmissions.

Aspects of the disclosure have been described as applicable to SC-FDMA. Alternatively, any example is applicable to use with Orthogonal Frequency Division Multiple Access (OFDMA).

1-20. (canceled)

21. A method, in a user equipment, for transmitting a demodulation reference signal in a communications network, the method comprising:
determining multiplexing information for the demodulation reference signal;
transmitting the demodulation reference signal using the multiplexing information in a same time allocation as a demodulation reference signal of another user equipment; and
transmitting data symbols associated with the demodulation reference signal in a separate time allocation of physical resources, and on a same physical frequency resource, to a time allocation of data symbols of the another user equipment.

22. The method of claim 21, wherein the separate physical resource allocation of the data symbols is a separate time allocation of a subframe, a slot, a physical resource block, a physical resource block pair, or a pair of subframes of the communication to another user equipment.

23. The method of claim 21:
wherein the user equipment transmits the reference signal and the data symbols in a period of a slot, a subframe, or two subframes;
wherein the reference signal is multiplexed with a reference signal of another user equipment in the slot, subframe, or two subframes; and
further comprising transmitting data symbols in a separate time allocation of the period of a slot, a subframe, or two subframes.

24. The method as of claim 21, wherein the determining multiplexing information for the reference signal comprises determining information to code multiplex the reference signal with one or more reference signal from the another user equipment.

25. The method of claim 21, further comprising generating the reference signal with a cyclic shift determined to provide code multiplexing with the one or more reference signal from the another user equipment.

26. The method of claim 21, further comprising generating the reference signal at frequency intervals to provide frequency multiplexing with the one or more reference signal from the another user equipment.

27. The method of claim 21, wherein the data symbols are transmitted within a transmission time interval which is less than a subframe and/or less than 1 millisecond.

28. The method of claim 21, wherein the data symbols are transmitted with a transmission time interval of 1, 2, 3, 4, 5, 6, 7, 8, 9, 10, 11, 12, or 13 symbols.

29. The method of claim 21, wherein the communication is a Physical Uplink Shared Channel communication, and/or the data symbols are Single Carrier Frequency Division Multiple Access symbols.

30. The method of claim 21, wherein the user equipment is communicating as part of a Multi-User Multiple In Multiple Out (MU-MIMO) communication with a further another user equipment.

31. The method of claim 21, wherein the transmitted symbols of the user equipment and the another user equipment are scheduled to be received on a same antenna port.

32. A method, in a base station, for communicating with user equipment in a communications network, the method comprising:
receiving a first reference signal from a first user equipment; and
receiving a second reference signal from a second user equipment;
receiving first data symbols from the first user equipment;
receiving second data symbols from the second user equipment;
wherein the first and second reference signals are multiplexed; and
wherein the data symbols from the first and second user equipment are received in a separate time allocation of physical resources and on a same physical frequency resource.

33. The method of claim 32, further comprising signaling the first and second user equipment with multiplexing information for the first and second reference signals respectively and/or signaling the first and second user equipment with information of a separate time allocation of physical resources for data symbol transmission.

34. The method of claim 33, wherein the multiplexing information is code multiplexing information and/or frequency multiplexing information.

35. The method of claim 32, wherein the first and second reference signals and the first and second data symbols are received in a single slot, physical resource block, subframe, physical resource block pair, or in an adjacent subframe or physical resource block pair.

36. A user equipment configured to transmit a demodulation reference signal in a communications network, the user equipment comprising:
processing circuitry configured to determining multiplexing information for the demodulation reference signal;
radio circuitry configured to:
transmit the demodulation reference signal using the multiplexing information in a same time allocation as a demodulation reference signal of another user equipment; and
transmit data symbols associated with the demodulation reference signal in a separate time allocation of physical resources, and on a same physical frequency resource, to a time allocation of data symbols of the another user equipment.

37. The user equipment of claim 36, wherein the user equipment is configured to code multiplex and/or frequency multiplex demodulation reference signals with the demodulation reference signals of the another user equipment.

38. A base station configured to communicate with user equipment in a communications network, the method comprising:
radio circuitry configured to:
receive a first reference signal from a first user equipment and a second reference signal from a second user equipment, wherein the first and second reference signal are multiplexed; and
receive first data symbols from the first user equipment and receive second data symbols from the second user equipment, wherein the data symbols from the first and second user equipment are in a separate time allocation of physical resources and on a same physical frequency resource.

39. The base station of claim 38:
further comprising processing circuitry configured to determine multiplexing information for the first and second reference signals and/or determine a separate time allocation of physical resources for data symbol transmission by the first and second user equipment;
wherein the radio circuitry is further configured to transmit such multiplexing information and/or information of the separate time allocation to the first and second user equipment.

40. A non-transitory computer readable recording medium storing a computer program product for controlling a user equipment for transmitting a demodulation reference signal in a communications network, the computer program product comprising software instructions which, when run on processing circuitry of the user equipment, causes the user equipment to:
determine multiplexing information for the demodulation reference signal;
transmit the demodulation reference signal using the multiplexing information in a same time allocation as a demodulation reference signal of another user equipment; and
transmit data symbols associated with the demodulation reference signal in a separate time allocation of physical resources, and on a same physical frequency resource, to a time allocation of data symbols of the another user equipment.

41. A non-transitory computer readable recording medium storing a computer program product for controlling a base station for communicating with user equipment in a communications network, the computer program product comprising software instructions which, when run on processing circuitry of the base station, causes the base station to:
receive a first reference signal from a first user equipment; and
receive a second reference signal from a second user equipment;
receive first data symbols from the first user equipment;
receive second data symbols from the second user equipment;
wherein the first and second reference signals are multiplexed; and
wherein the data symbols from the first and second user equipment are received in a separate time allocation of physical resources and on a same physical frequency resource.
